(19) United States
(12) Patent Application Publication
(10) Pub. No.: US 2025/0080395 A1
(43) Pub. Date: Mar. 6, 2025

(54) EXTREME VALIDATION FOR FAULT DETECTION

(71) Applicant: DISH Wireless L.L.C., Littleton, CO (US)

(72) Inventor: Arpit Agarwal, Highlands Ranch, CO (US)

(21) Appl. No.: 18/459,693

(22) Filed: Sep. 1, 2023

(51) Int. Cl. H04L 41/0631; G06F 11/07; H04L 41/0677

(52) U.S. Cl. CPC H04L 41/0631; G06F 11/0793; H04L 41/0677

(57) ABSTRACT

A method may include accessing data associated with a failure of a 5G network component. The method may include providing the data associated with the failure of the 5G network component to a first machine learning model, configured to determine and output data indicating a root cause of the failure. The method may include providing data indicating the root cause of the failure to a second machine learning model, configured to determine and output data indicating one or more service providers and respective destinations associated with the root cause. The method may include generating a service ticket may include data indicating the root cause and the respective destinations associated with the root cause. The method may include transmitting the service ticket to the respective destinations of the one or more service providers associated with the root cause of the failure.

### BACKGROUND

As networks grow more complex, causes of errors and failures of components of the networks become more difficult to determine. Furthermore, logs associated with each of the components may include different data, obscuring a root cause of the errors and failures. Resolving the errors and failures may therefore take days, weeks, or longer to identify and resolve.

### BRIEF SUMMARY

A method may include accessing, by a computing device, data associated with a failure of a 5G network component. The method may include providing, by the computing device, the data associated with the failure of the 5G network component to a first machine learning model, where the first machine learning model is configured to determine and output data indicating a root cause of the failure. The method may include providing, by the computing device, data indicating the root cause of the failure to a second machine learning model, where the second machine learning model is configured to determine and output data indicating one or more service providers and respective destinations associated with the root cause of the failure of the 5G network component. The method may include generating, by the computing device, a service ticket may include data indicating the root cause of the failure of the 5G network component and the respective destinations associated with the root cause of the failure of the 5G network component. The method may include transmitting, by the computing device, the service ticket to the respective destinations of the one or more service providers associated with the root cause of the failure.

In some embodiments, the method may include receiving, by the first machine learning model, an error log associated with the failure of the 5G network component. The method may include identifying, by the first machine learning model, a line in the error log that corresponds to the failure of the 5G network component. The method may include determining, by the first machine learning model, the root cause of the failure, based at least in part on the line in the error log. The method may include outputting, by the first machine learning model, the data indicating the root cause of the failure of the 5G network component.

In some embodiments, the method may include receiving, by the second machine learning model, the data indicating the root cause of the failure of the 5G network component. The method may include determining, by the second machine learning model, one or more service providers and respective destinations based at least in part on the data indicating the root cause, the one or more service providers associated with the root cause of the failure of the 5G network component. The method may include determining, by the second machine learning model, one or more individuals of the one or more service providers associated with the failure of the 5G network component. The method may include outputting, by the second machine learning model, data indicating at least one of the one or more service providers, the one or more individuals, and the respective destinations.

In some embodiments, the method may include receiving, by the computing device, a feedback ticket associated with the service ticket. The feedback ticket may include a first accuracy rating corresponding to the root cause of the failure of the 5G network component and a second accuracy rating corresponding to at least one of the one or more service providers, the respective destinations, and the one or more individuals. The method may include retraining, by the computing device, the first machine learning model based at least in part on the first accuracy rating. The method may include retraining, by the computing device, the second machine learning model based at least in part on the second accuracy rating. In some embodiments, the service ticket may include a link to user data identified by the computing device. The first machine learning model may be trained at least in part on historical error logs. The second machine learning model may be trained at least in part on historical service tickets and/or on service provider data.

In some embodiments, the method may include accessing, by the computing device, data associated with a second failure of a second 5G network component. The method may include providing, by the computing device, the data associated with the second failure of the second 5G network component to the first machine learning model, such that the first machine learning model outputs data indicating a root cause of the second failure. The method may include providing, by the computing device, the data indicating the root cause of the second failure of the second 5G network component to the second machine learning model such that the second machine learning model outputs data indicating one or more service providers and respective destinations associated with the root cause of the second failure of the second 5G network component. The method may include determining, by the computing device, the failure of the 5G network component and the second failure of the second 5G network component share a common root cause and are associated with the one or more service providers and respective destinations. The method may include generating, by the computing device, a single service ticket may include data indicating the common root cause of the failure of the 5G network component and the second failure of the second 5G network component, indicating the respective destinations. The method may include transmitting, by the computing device, the single service ticket to the respective destinations of the one or more service providers associated with the common root cause.

A computing system may include one or more processors, a network monitor, an error identification module, a routing module, a service ticket generator, and a non-transitory computer-readable medium may include instructions that, when executed by the one or more processors, cause the system to perform operations to. According to the operations, the network monitor may access data associated with a failure of a 5G network component. The network monitor may provide the data associated with the failure of the 5G network component to the error identification module, where error identification module is configured to determine and output data indicating a root cause of the failure. The error identification module may provide the data indicating the root cause of the failure to the routing module, where the routing module is configured to determine and output data indicating one or more service providers and respective destinations associated with the root cause of the failure of the 5G network component. The service ticket generator may generate a service ticket may include data indicating the root cause of the failure of the 5G network component and the respective destinations associated with the root cause of the failure of the 5G network component. The computing system may transmit the service ticket to the respective destinations of the one or more service providers associated with the root cause of the failure.

In some embodiments, the error identification module may include a machine learning model trained at least in part on historical error logs. The routing module may include a machine learning model trained at least in part on historical service tickets. The computing system may be implemented on a distributed cloud-based architecture. The 5G network may be a standalone 5G network implemented on a distributed cloud-based architecture.

A non-transitory computer-readable medium may include instructions that, when executed by a processor, cause the processor to perform operations including accessing, by a computing device, data associated with a failure of a 5G network component. The operations may include providing, by the computing device, the data associated with the failure of the 5G network component to a first machine learning model, where the first machine learning model is configured to determine and output data indicating a root cause of the failure. The operations may include providing, by the computing device, data indicating the root cause of the failure to a second machine learning model, where the second machine learning model is configured to determine and output data indicating one or more service providers and respective destinations associated with the root cause of the failure of the 5G network component. The operations may include generating, by the computing device, a service ticket may include data indicating the root cause of the failure of the 5G network component and the respective destinations associated with the root cause of the failure of the 5G network component. The operations may include transmitting, by the computing device, the service ticket to the respective destinations of the one or more service providers associated with the root cause of the failure.

In some embodiments, operations may include receiving, by the first machine learning model, an error log associated with the failure of the 5G network component. The operations may include identifying, by the first machine learning model, a line in the error log that corresponds to the failure of the 5G network component. The operations may include determining, by the first machine learning model, the root cause of the failure, based at least in part on the line in the error log; and outputting, by the first machine learning model, the data indicating the root cause of the failure of the 5G network component.

In some embodiments, the operations may include receiving, by the second machine learning model, the data indicating the root cause of the failure of the 5G network component. The operations may include determining, by the second machine learning model, one or more service providers and respective destinations based at least in part on the data indicating the root cause, the one or more service providers associated with the root cause of the failure of the 5G network component. The operations may include determining, by the second machine learning model, one or more individuals of the one or more service providers associated with the failure of the 5G network component. The operations may include outputting, by the second machine learning model, data indicating at least one of the one or more service providers, the one or more individuals, and the respective destinations.

In some embodiments, the operations may include receiving, by the computing device, a feedback ticket associated with the service ticket. The feedback ticket may include a first accuracy rating corresponding to the root cause of the failure of the 5G network component and a second accuracy rating corresponding to at least one of the one or more service providers, the respective destinations, and the one or more individuals. The operations may include retraining, by the computing device, the first machine learning model based at least in part on the first accuracy rating. The operations may include retraining, by the computing device, the second machine learning model based at least in part on the second accuracy rating. The 5G network may be a standalone 5G network implemented on a distributed cloud-based architecture. The first machine learning model may be trained at least in part on historical error logs. The second machine learning model may be trained at least in part on historical service tickets and/or on service provider data.

### BRIEF DESCRIPTION OF THE DRAWINGS

FIG. 1A illustrates an embodiment of a cellular network system, according to certain embodiments.

FIG. 1B illustrates an exemplary core, according to certain embodiments.

FIG. 2 illustrates an embodiment of a cellular network core network topology as implemented on a public cloud-computing platform, according to certain embodiments.

FIG. 3 illustrates a system and a process of determining and validating an error in a 5G network, according to certain embodiments.

FIG. 4 illustrates a simplified block diagram of a system for error detection and routing, according to certain embodiments.

FIG. 5 illustrates a block diagram of a system for training a machine learning model for identifying a root cause of an error, according to certain embodiments.

FIG. 6 illustrates a block diagram of a system for training a machine learning model for identifying a root cause of an error, according to certain embodiments.

FIG. 7 illustrates a system for providing a single service ticket associated with errors sharing a common root cause to a service provider, according to certain embodiments.

FIG. 8 illustrates a flowchart of a method for determining a root cause of an error and delivering a service ticket, according to certain embodiments.

### DETAILED DESCRIPTION

A 5G wireless network may include several network components working in conjunction with one another in order to provide wireless service across a region. Some or all of the network components may be implemented via a cloud-based architecture, hosted by a public cloud-services provider (e.g., Amazon Web Services®, Microsoft Azure®, etc.). One advantage to a cloud-based architecture like the one described above may be an ability to generate more components in order to meet an expected service need. For example, a wireless network may include both hardware and software components. If network traffic exceeds a capacity of a hardware component, adding additional hardware components may increase the capacity of the wireless network. Adding more hardware components may be both slow and expensive, and thus may generally be able to handle significantly more network traffic than expected.

By contrast, software-based network components may have a capacity significantly lower than the capacity of hardware-based components. The software components (sometimes “network components”), however, may be quickly replicated, with multiple instances of the same network component performing similar tasks within the wireless network. In wireless networks where the software components are hosted by the 5G wireless network provider, a limiting factor may be the amount of storage and/or processing power the 5G wireless network provider owns. In a cloud-based architecture, however, the amount of storage and processing power available may far exceed that of the 5G wireless network provider, allowing more software components to be created essentially at will.

In order to create more network components, a 5G wireless network provider may need to know which network components will fail at what point. For example, during a period of unusually high voice volume on a wireless network, an Internet Protocol Multimedia Service (IMS) may fail. During a period of unusually high application data volume on the wireless network, a user plane function (UPF may fail). Other data types may cause other failures. However, typical wireless network traffic may generally include a high volume of solely a particular data type (e.g., voice data, application data, multimedia messaging service data, etc.), but rather a data mix composed of various data types at various respective levels. The data mix of wireless network traffic may vary constantly, with the amounts of each data type changing independently at all times. Specific data mixes at any given point may cause yet other failures, sometimes unpredictably.

In order to address any technical issues that arise from these failures, efficient identification of a root cause of the failure may be crucial. Error logs may be generated from one or more of the network components, each error log including thousands of lines. Data included in the error logs may be used to identify the root cause of the failure (or error), including any components that may be involved in the failure. In some cases, the error logs may include information clearly identifying the root cause of the error in a single line. The 5G network may include many components, however, and the failure may not occur due to just one network component, but due in part to multiple network components and/or the interactions thereof. The error logs may not clearly identify the root cause, then, but rather “imply” the root cause based on a status of multiple lines of the error log.

For example, a 5G network may include a first network component and a second network component. The first network component may process some or all of the data in a data mix flowing through the 5G network and pass the processed data to the second network component. When exposed to a certain data mix, the first network component may not fail—that is, may not cease operation—but may begin to provide faulty data to the second network component. The second network component may then fail in response to the faulty data. Thus, the 5G network may cease operation because of a failure of the second network component, but the root cause may be the first network component (or the interaction between the first and second network components). An error log may clearly identify the failure of the second network component, but the faulty data provided by the first network component may not be clearly linked to the failure of the second network component. Thus, determining the root cause of the failure of the 5G network may take an inordinate amount of time.

While the example above only describes two network components, 5G networks may have any number of network components. In 5G networks with several network components, and potentially several instances of each, the interactions between the network components may be even more complex and hard to parse. Thus, determining a root cause may take a long time, even if the error logs include information clearly defining the root cause. Once the root cause of the error is identified, a service ticket may be generated and routed to a party responsible for whichever component(s) failed. This process may take days or weeks to resolve, potentially leading to undue down time of a live 5G network. Even in a testing environment, the days or weeks may cause yet more failures or errors, as the root cause of the first failure has yet to be fixed or maybe even identified.

Adding to the complexity, there may be one or more service providers associated with some or all of the network components. As individuals change roles, jobs, retire, etc., the information needed to route the service ticket to the needed service provider and/or individual may change. Tracking the correct destination, therefore, may present its own set of logistical problems. Thus, even once the root cause is identified and the service ticket is generated, delivery of the service ticket to the correct service provider and/or individual may be delayed or fail completely, leading to even more delays.

One solution to the inefficiencies of identifying the root causes of failures (and/or errors) may be to utilize one or more machine learning models (MLMs) to identify the root causes of failures and errors and confirm delivery of a service ticket to the correct service provider. A computing device may monitor the performance of a 5G network. The computing device may detect a failure of one or more network components of the 5G network and collect data associated with the failure. For example, the computing device may access one or more error logs from some or all of the network components included in the 5G network. The computing device may then provide the data associated with the failure to a first MLM. The first MLM may be trained on historical error logs from previous failures of the 5G network and/or other 5G networks. The first MLM may parse the error log(s) to identify the root cause of the failure. The root cause of the failure may include one or more network components, an interaction between two or more network components, a data mix, and other data associated with the 5G network. The first MLM may output data indicating the root cause of the failure.

The computing device may then provide the data indicating the root cause of the failure to a second MLM. The second MLM may be trained using historical service tickets, service provider data, and other such data. The second MLM may then determine one or more service providers associated with the root cause of the failure, a destination(s) thereof, and other data associated with the one or more service providers. The second MLM may then output data indicating the one or more service providers, the respective destination associated with each of the one or more service providers, the data indicating the root cause of the failure, and other such data.

Using the output of the second MLM, the computing device may then generate a service ticket, including some or all of the data output by the first and second MLMs. The service ticket may then be routed to the correct service providers and/or individuals. By using the systems and techniques described herein, the root cause of failures and errors may be efficiently determined, saving time. Further adding to the efficiency gains, the service ticket(s) associated with the failure may be routed more efficiently (and/or effectively), allowing the failure or error to be rectified sooner. Because the root cause may be determined and rectified sooner, the 5G network may become more robust, experiencing less downtime thus providing more consistent service.

Although the systems and techniques are described herein in relation to a 5G network, the broader applicability of the systems and techniques should be clear. Any complex computing network may benefit by employing features disclosed herein. Furthermore, it should be understood that “failure” and “error” may be used interchangeably. That is, “error” may imply a failure of a component or network and “failure” may indicate a malfunction of a component or network instead of a complete failure.

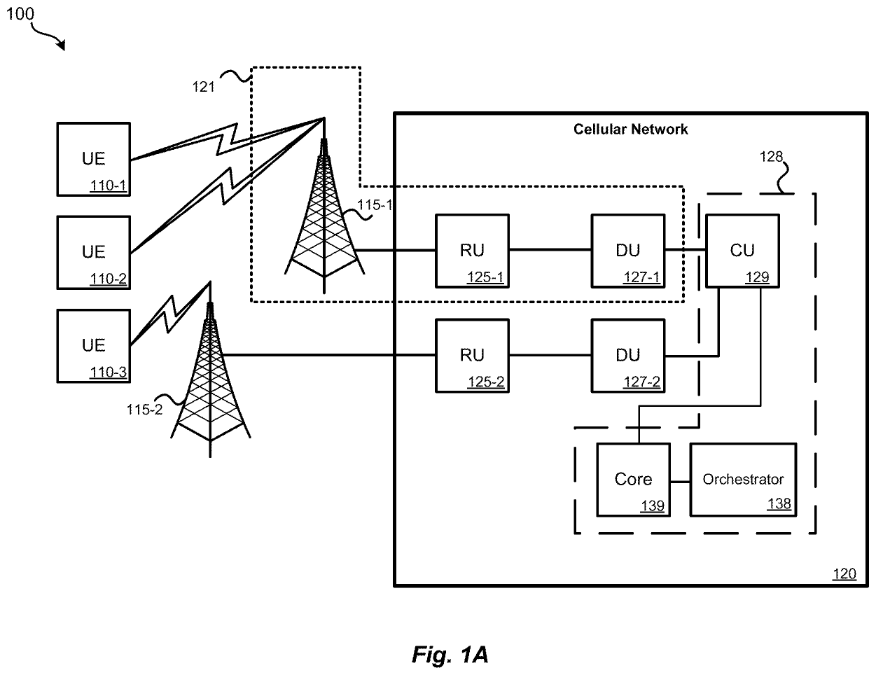

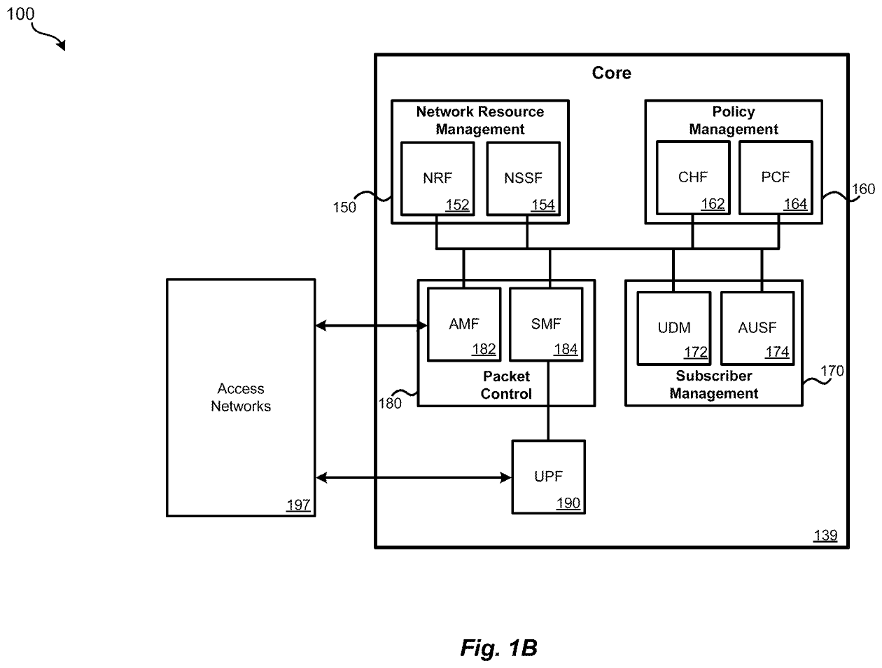

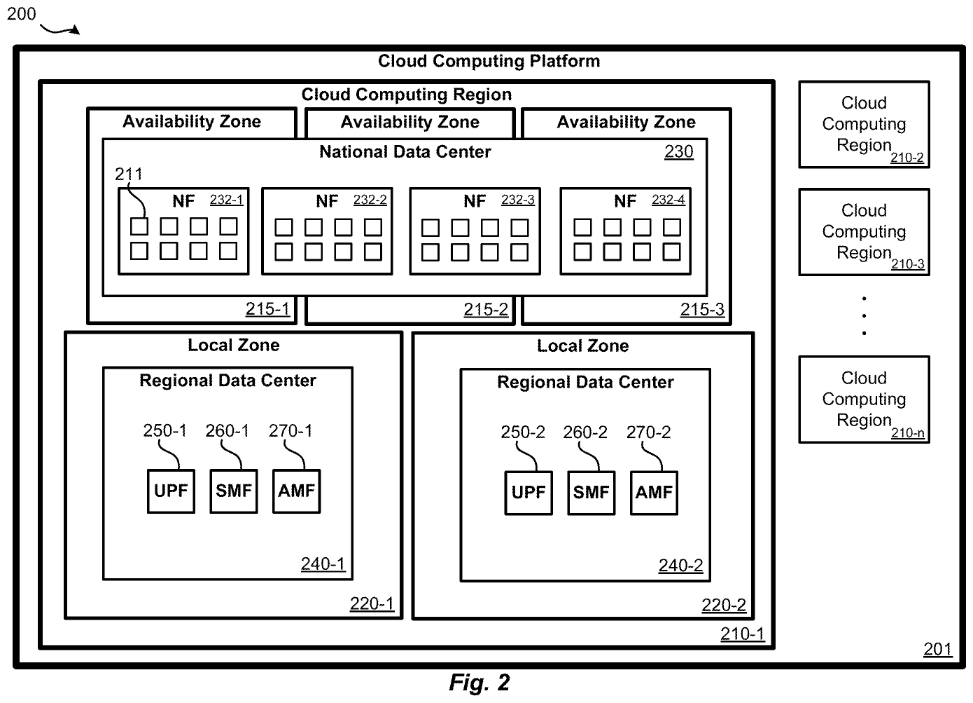

FIG. 1A illustrates an embodiment of a cellular network system 100 (“system 100”), according to certain embodiments. System 100 can include a 5G New Radio (NR) cellular network; other types of cellular networks, such as 4G LTE, 6G, 7G, etc. are also possible. System 100 can include: UE 110 (UE 110-1, UE 110-2, UE 110-3); base station 115; cellular network 120; radio units 125 (“RUs 125”); distributed units 127 (“DUs 127”); centralized unit 129 (“CU 129”); core 139, and orchestrator 138. FIG. 1A represents a component level view. In a virtualized open radio access network (O-RAN), because components can be implemented as software in the cloud, except for components that need to receive and transmit RF, the functionality of various components can be shifted among different servers, for which the hardware may be maintained by a separate (public) cloud-service provider, to accommodate where the functionality of such components is needed, as detailed in relation to FIG. 2.

UE 110 can represent various types of end-user devices, such as smartphones, cellular modems, cellular-enabled computerized devices, sensor devices, manufacturing equipment, gaming devices, access points (APs), any computerized device capable of communicating via a cellular network, etc. UE can also represent any type of device that has incorporated a 5G interface, such as a 5G modem. Examples include sensor devices, Internet of Things (IoT) devices, manufacturing robots; unmanned aerial (or land-based) vehicles, network-connected vehicles, environmental sensors, etc. UE 110 may use RF to communicate with various base stations of cellular network 120. As illustrated, two base stations 115 (BS 115-1, 115-2) are illustrated. Real-world implementations of system 100 can include many (e.g., hundreds, thousands) of base stations, and many RUs, DUs, and CUs. BS 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT, such as 4G Long Term Evolution (LTE). The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1) located on site at the base station. In some embodiments, the DU may be physically remote from the RU. For instance, multiple DUs may be housed at a central location and connected to geographically distant (e.g., within a couple kilometers) RUs.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, RUs, DUs, and CUs create a gNodeB, which serves as the radio access network (RAN) of cellular network 120. CU 129 can communicate with core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or core 139. Other DUs may or may not have this capability.

At a high level, the various components of a gNodeB can be understood as follows: RUs perform RF-based communication with UE. DUs support lower layers of the protocol stack such as the radio link control (RLC) layer, the medium access control (MAC) layer, and the physical communication layer. CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

Further detail regarding exemplary core 139 is provided in relation to FIG. 1B. FIG. 1B illustrates an exemplary core 139, according to certain embodiments. The exemplary core 139 can be physically distributed across data centers or located at a central national data center (NDC) as detailed in relation to FIG. 2, can perform various core functions of the cellular network. Core 139 can include: network resource management components 150; policy management components 160; subscriber management components 170; and packet control components 180. Individual components may communicate on a bus, thus allowing various components of core 139 to communicate with each other directly. Core 139 is simplified to show some key components. Implementations can involve additional other components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE.

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UE.

Packet control components 180 can include: Access and Mobility Management Function (AMF) 182 and Session Management Function (SMF) 184. AMF 182 can receive connection-and session-related information from UE and is responsible for handling connection and mobility management tasks. SMF 184 is responsible for interacting with the decoupled data plane, creating updating and removing Protocol Data Unit (PDU) sessions, and managing session context with the User Plane Function (UPF).

User plane function (UPF) 190 can be responsible for packet routing and forwarding, packet inspection, QoS handling, and external PDU sessions for interconnecting with a Data Network (DN) (e.g., the Internet) or various access networks 197. Access networks 197 can include the RAN of cellular network 120 of FIG. 1A.

While FIGS. 1A and 1B illustrate various components of cellular network 120, it should be understood that other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In a virtualized arrangement, specialized software on general-purpose hardware may be used to perform the functions of components such as DU 127, CU 129, and core 139. Functionality of such components can be co-located or located at disparate physical server systems. For example, certain components of core 139 may be co-located with components of CU 129.

In a possible O-RAN implementation, DUs 127, CU 129, core 139, and/or orchestrator 138 can be implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, core 139, and orchestrator 138. In some embodiments, DUs 127 may be partially or fully added to cloud-based cellular network components 128. Such cloud-based cellular network components 128 may be executed as specialized software executed by underlying general-purpose computer servers. Cloud-based cellular network components 128 may be executed on a public third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested. A “public” cloud-based computing platform refers to a platform where various unrelated entities can each establish an account and separately utilize the cloud computing resources, the cloud computing platform managing segregation and privacy of each entity's data.

Kubernetes, or some other container orchestration platform, can be used to create and destroy the logical DU, CU, or 5G core units and subunits as needed for the cellular network 120 to function properly. Kubernetes allows for container deployment, scaling, and management. As an example, if cellular traffic increases substantially in a region, an additional logical DU or components of a DU may be deployed in a data center near where the traffic is occurring without any new hardware being deployed. (Rather, processing and storage capabilities of the data center would be devoted to the needed functions.) When the need for the logical DU or subcomponents of the DU no longer exists, Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU, orchestrator 138 can perform a pipeline of calling the DU code from a software repository incorporated as part of, or separate from, cellular network 120; pulling corresponding configuration files (e.g., helm charts); creating Kubernetes nodes/pods; loading DU containers; configuring the DU; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular SLA levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 1A, UE 110 may be operating on one or more production slices of cellular network 120. As detailed later in this document, UE that function on a particular entity's local network may be assigned to a slice particular to the entity or a slice that provides a particular QoE for tasks to be performed by the entity's UE.

Components such as DUs 127, CU 129, orchestrator 138, and core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

FIG. 2 illustrates an embodiment of a cellular network core network topology 200 as implemented on a public cloud-computing platform, according to certain embodiments. Cellular network core network topology 200 can represent how logical cellular network groups are distributed across cloud computing infrastructure of cloud computing platform 201. Cloud computing platform 201 can be logically and physically divided up into various different cloud computing regions 210. Each of cloud computing regions 210 can be isolated from other cloud computing regions to help provide fault tolerance, fail-over, load-balancing, and/or stability and each of cloud computing regions 210 can be composed of multiple availability zones, each of which can be a separate data center located in general proximity to each other (e.g., within 600 miles). Further, each of cloud computing regions 210 may provide superior service to a particular geographic region based on physical proximity. For example, cloud computing region 210-1 may have its datacenters and hardware located in the northeast of the United States while cloud computing region 210-2 may have its datacenters and hardware located in California. For simplicity, the details of the cellular network as executed in only cloud computing region 210-1 is illustrated. Similar components may be executed in other cloud computing regions of cloud computing regions 210 (210-2, 210-3, 210-n).

In other embodiments, cloud computing platform 201 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 210 may include multiple availability zones 215. Each of availability zones 215 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 215. For example, a database that is maintained as part of NDC 230 may be replicated across availability zones 215; therefore, if an availability zone of the cloud computing region is unavailable, a copy of the database remains up-to-date and available, thus allowing for continuous or near continuous functionality.

On a (public) cloud computing platform, cloud computing region 210-1 may include the ability to use a different type of data center or group of data centers, which can be referred to as local zones 220. For instance, a client, such as a provider of the hybrid cloud cellular network can select from more options of the computing resources that can be reserved at an availability zone compared to a local zone. However, a local zone may provide computing resources nearby geographic locations where an availability zone is not available. Therefore, to provide low latency, certain network components, such as regional data centers, can be implemented at local zones 220 rather than availability zones 215. In some circumstances, a geographic region can have both a local zone and an availability zone.

In the topology of a 5G NR cellular network, 5G core functions of core 139 can logically reside as part of a national data center (NDC). NDC 230 can be understood as having its functionality existing in cloud computing region 210-1 across multiple availability zones 215. At NDC 230, various network functions, such as NFs 232, are executed. For illustrative purposes, each NF, whether at NDC 230 or elsewhere located, can be comprised of multiple sub-components, referred to as pods (e.g., pod 211) that are each executed as a separate process by the cloud computing environment. The illustrated number of pods is merely an example; fewer or greater numbers of pods may be part of the respective 5G core functions. It should be understood that in a real-world implementation, a cellular network core, whether for 5G or some other standard, can include many more network functions. By distributing NFs 232 across availability zones, load-balancing, redundancy, and fail-over can be achieved. In local zones 220, multiple regional data centers 240 can be logically present. Each of regional data centers 240 may execute 5G core functions for a different geographic region or group of RAN components. As an example, 5G core components that can be executed within an RDC, such as RDC 240-1, may be: UPFs 250, SMFs 260, and AMFs 270. While instances of UPFs 250 and SMFs 260 may be executed in local zones 220, SMFs 260 may be executed across multiple local zones 220 for redundancy, processing load-balancing, and fail-over.

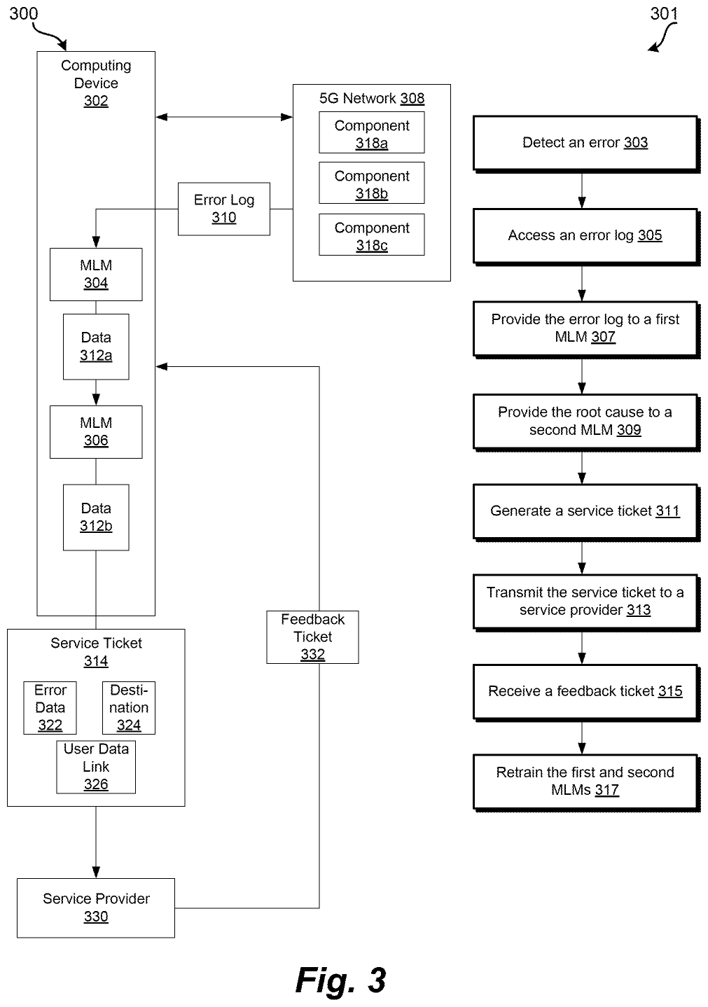

FIG. 3 illustrates a system 300 and a process 301 of determining and validating an error in a 5G network 308. The system 300 may include a computing device 302. The computing device may include a first MLM 304 and a second MLM 306. The computing device 302 (and components thereof) may be a single computing device or may be implemented in a distributed cloud-based computing architecture. The computing device 302 may be hosted by a public cloud-service provider (e.g., Microsoft Azure®, Amazon Web Service®, etc.).

The 5G network 308 may be a 5G wireless network, configured to provide wireless services to UE. As such, the 5G network 308 may be similar to the system 100 described in FIGS. 1A and 1B. Additionally, the 5G wireless network may be implemented in the cloud, as is described in FIG. 2. The 5G network 308 may include network components 318a-c. The network components 318a-c may be hardware and/or software components, such an RU, and AMF, an SMF, etc. Furthermore, the 5G network 308 may be implemented in a testing environment and be a replica of a live 5G network. Alternatively, the 5G network 308 may be a live 5G network, providing wireless services to one or more UE's.

At step 303, the computing device 302 may detect an error within the 5G network 308. The error may include a complete failure of the 5G network, including a disruption in service to one or more UE's connected to the 5G network 308. Additionally or alternatively, the error may include a degradation of performance in the 5G network 308. The error may be associated with one or more of the network components 318a-c. For example, the network component 318a may be a UPF and fail due to heavier than expected network traffic. In another example, the network component 318b may be a DU and the network component 318c may be a CU. Connectivity between the network component 318b and the network component 318c may be lost due to the failure of one or more subsystems of one or both of the network components 318b-c.

At step 305, the computing device 302 may access the error log 310. The error log 310 may include data associated with the error within the 5G network 308, such as a data mix and other network statistics at the time of the error, information indicating a failure of one or more of the network components 318a-c, performance metrics of the 5G network 308 and other such data. Although only one error log 310 is shown, any number of error logs may be accessed by the computing device 302. For example, the computing device 302 may access an error log associated with one or more of network components 318a-c and/or access logs generated internally by the computing device 302 by a network monitor or other such component.

At step 307, the computing device 302 may provide the error log 310 to the MLM 304. The MLM 304 may be trained, at least in part, on historical error logs, to determine a root cause of the error. Using the historical error logs, the MLM 304 may associate specific values in certain lines of error logs (e.g., the error log 310) with the root cause. Thus, to determine the root cause, the MLM 304 may parse lines included in the error log 310. In parsing the lines of the error log 310, the MLM 304 may identify one or more lines in the error log 310 that are associated with an obvious root cause (e.g., a failure of the network component 318a). The MLM 304 may also determine that certain values within lines included in the error log 310 are associated with less obvious failures, such as an interaction between two or more of the network components 318a-c. The root cause of the error may include a data mix at the time of the failure, a failure or malfunction by one or more of the network components 318a-c (or the interactions thereof), or other suitable causes. The MLM 304 may output data 312a. The data 312a may indicate the root cause of the error, any of the network components 318a-c that may be involved or affected by the error, any user data associated with the error, and other such information. Once identified, the user data associated with the error may be stored in a memory or database of the computing device 302 or some other computer memory.

At step 309, the computing device may provide the data 312a to the MLM 306. The MLM 306 may be trained, at least in part, on historical service tickets. The historical service tickets may include information indicating one or more service providers associated with past errors similar to the error indicated in the data 312a. For example, if the root cause of the error indicated in the data 312a is the network component 318c, the MLM 306 may associate the root cause with a first service provider. However, based on previous errors, the MLM 306 may further determine that a second service provider must also be involved in a solution to the error. For example, the network components 318b-c may be associated with first and second service providers, respectively. The network component 318b may provide processed data to the network component 318c. While the network component 318c may be the root cause of the error, the network component 318b may require reconfiguration after the network component 318c is repaired. The MLM 306 may therefore automatically determine that both the first and second service providers are associated with the error indicated in the data 312a, even though only the network component 318c failed.

The MLM 306 may also be trained on service provider data. The service provider data may include contact information associated with each of the one or more service providers associated with the network component 318a-c. The service provider data may also include a list of individuals of each of the service provider responsible for some part of the root cause of the error. For example, the service provider data may include one or more names of engineers, project managers, team leads, etc. associated with the root cause. Continuing the example from above, the MLM 306 may identify an engineer and a team lead whose responsibilities are associated with the root cause of the error for each of the network components 318b-c. The MLM 306 may also determine a destination associated with each of the one or more service providers and/or individuals thereof. The destination may include an internet protocol (IP) address, email address, private endpoint connection, or any other such information that may be used to route data. The MLM 306 may then output data 312b. The data 312b may indicate the one or more service providers (e.g., a service provider 330) associated with the root cause of the error, individuals of the one or more service providers, the relevant destinations, etc.

At step 311, the computing device 302 may generate a service ticket 314. The service ticket 314 may be based, at least in part on the data 312a-b. The service ticket 314 may include error data 322, a destination 324, and a user data link 326. The error data 322 may include the root cause of the error, information identifying the one or more network components 318a-c involved in or affected by the error, network statistics associated with the 5G network 308 at the time of the error, and other such information associated with the error. The destination 324 may include an email address, IP address, etc. associated with the service provider 330, as determined by the MLM 306. The user data link 326 may include a hypertext transfer protocol (HTTP) link, a file transfer protocol (FTP) link, or any other suitable link to the user data. The user data link 326 may cause the user data associated with the error to be downloaded and/or displayed on a computing device.

The service ticket 314 may be generated, at least in part utilizing a third MLM. The third MLM may determine a severity of the service ticket 314. For example, the error indicated in the data 312a may be causing a major impact to the 5G network 308. Therefore, the third MLM may indicate that the service ticket 314 (and error contained therein) are a highest priority, and that the service ticket 314 should be addressed before any other service tickets. Furthermore, the third MLM may consider other open service tickets, and compare the severity of the other open service tickets (and the work done thereon) to the severity of the service ticket 314. For example, another open service ticket may be of a lower severity than that of the service ticket 314. Thus, the third MLM may set a priority of the service ticket 314 indicating that work should begin on the root cause of the error before the other open service ticket is completed. In another example, the work to resolve the other open service ticket may be at or near completion. Then, the third MLM may set the priority of the service ticket 314 to be below the other open service ticket, indicating that work should begin on the root cause of the problem after resolution of the other open service ticket.

At step 313, the computing device 302 may transmit the service ticket 314 to the service provider 330. The computing device 302 may transmit the service ticket 314 based at least in part on the destination 324. Although only one service provider 330 is shown, the service ticket 314 may be transmitted to multiple service providers. In some embodiments, the service ticket 314 may include identical data for each of the multiple service providers. In other embodiments, each service ticket may include only that data that is relevant to the corresponding service provider.

In some embodiments, the computing device 302 may monitor the root cause error indicated in the service ticket 314/data 312a. For example, the computing device 302 may determine that the root cause of the error is being addressed appropriately and take no further action. In other examples, the computing device 302 may determine that the root cause of the error is not being addressed. For example, the service ticket 314 may be routed to an individual no longer associated with the service provider 330. Thus, the service provider 330 may be unaware of the service ticket 314 (and thus the root cause of the error). The computing device 302 may then use one or more of components described above to generate a new service ticket, and/or escalate the service ticket 314 (e.g., transmit the service ticket 314 to a team lead or other individual of the service provider 330).

At step 315, the computing device 302 may receive a feedback ticket 332 from the service provider 330. The feedback ticket 332 may include an error accuracy rating corresponding to the root cause of the error. The error accuracy rating may include data indicating how well the MLM 304 identified the root cause of the error. For example, if the MLM 304 correctly identified the root cause of the error as being a failure of the network component 318a, the error accuracy rating may include a maximum value (e.g., 10 on a scale of 1-10). If the root cause of the error was only partially identified (e.g., the network component 318a failed but the network component 318b was also malfunctioning), the error accuracy rating may include a less-than maximum value (e.g., a 7 on a scale of 1-10). If the root cause of the error was incorrectly identified (e.g., the network component 318a failed but the network component 318c was identified in the error data 322), the error accuracy rating may include a minimal value (e.g., 0 on a scale of 1-10). The scales described above are by way of example only; one of ordinary skill in the art would recognize many different techniques for accuracy ratings that may be used. Furthermore, the feedback ticket 332 may include a corrected root cause of the error. For example, the service ticket 314 may indicate a first root cause of the error. The service provider 330, however, may determine that the actual root cause is a second root cause, not included in the service ticket 332. Thus, the feedback ticket 332 may include the actual root cause of the error.

The feedback ticket 332 may also include a routing accuracy rating corresponding to the service provider 330, one or more individuals of the service provider 330, and/or the destination 324. For example, if the service ticket 314 was transmitted to the correct service provider, but the wrong individual of the service provider, the routing accuracy rating may be less than a maximum value. Similarly, if the service ticket 314 was provided only to the service provider 330, but a solution to the root cause of the error requires input from an additional service provider, the routing accuracy rating may also be less than a maximum value. In the event that the routing accuracy rating includes less than a maximum value, the feedback ticket 332 may also include updated information. For example, if the service ticket 314 was not routed to a required individual of the service provider 330, information indicating a destination associated with the required individual may be included in the feedback ticket 332.

At step 317, the MLMs 304 and 306 may be retrained using the error accuracy rating, the routing accuracy rating, and/or other data provided in the feedback ticket 332 (e.g., an actual root cause). Based at least in part on the error accuracy rating, the MLM 304 may be altered to associate the values in one or more of the lines in the error log 310 with a new root cause. The new root cause may be similar to the root cause, but include another component, performance metric, network statistic, etc. Thus, the MLM 304 may more accurately determine a root cause of a subsequent error based on a related error log.

The MLM 306 may be altered based at least in part on the routing accuracy rating and/or the data provided in the feedback ticket 332. Continuing the example from above, the feedback ticket may include a destination of a required individual of the service provider 330. The MLM 306 may then associate the root cause identified in the data 312a with the destination of the required individual of the service provider 330. Thus, subsequent service tickets may be routed more accurately by the computing device 302.

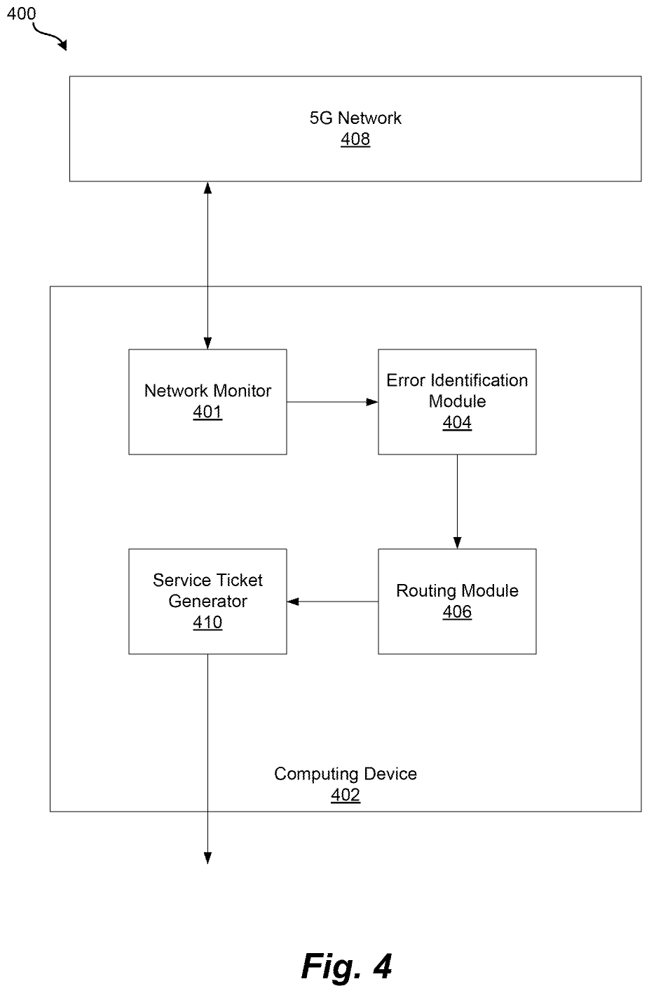

FIG. 4 illustrates a simplified block diagram of a system 400 for error detection and routing, according to certain embodiments. The system 400 may be similar to the system 300 in FIG. 3. The system 400 may include a computing device 402. The computing device 402 may be similar to the computing device 302 and include a network monitor 401, an error identification module 404, a routing module 406, and a service ticket generator 410. The computing device 402 may be a single device or may be implemented in a cloud-based architecture.

The network monitor 401 may be configured to determine one or more performance metrics associated with a 5G network 408. The one or more performance metrics may include a packet loss rate, a response rate for data flowing through the 5G network 408, and other metrics. The network monitor 401 may also be configured to access one or more logs generated by components of the 5G network 408 (e.g., the network components 318a-c in FIG. 3). The network monitor 401 may also generate logs independently, based at least in part on the one or more performance metrics. For example, the network monitor 401 may determine that a particular performance metric dropped below a certain threshold.

The network monitor 401 may then generate an error log that includes data associated with a state of the 5G network 408 at the time the particular performance metric dropped below the certain threshold (together, sometimes “network metadata”). The network metadata may include a data mix, a status of one or more components of the 5G network 408, a number of UE's connected to the 5G network 408, user data associated with one or more of the UE's connected to the 5G network 408, and any other such data. The network monitor 401 may also access error logs associated with components of the 5G network 408. In some embodiments, the network monitor 401 may generate a respective error log for each component of the 5G network 408. In other embodiments, the network monitor 401 may access the respective error logs from each component and/or another component of the 5G network 408.

The network monitor 401 may then provide some or all of the error logs to the error identification module 404. The error identification module 404 may include an MLM such as the MLM 304 in FIG. 3. The error identification module 404 may also include and/or access one or more databases and/or other computer memories that include historical error logs and/or other data associated with 5G network errors. The error identification module 404 may utilize the historical error logs and/or other data to determine a root cause of the error based at least in part on some or all of the error logs provided by the network monitor 401.

The MLM may include and/or employ an artificial neural network, Bayesian network, ridge regression model, K-nearest neighbors, and/or other machine learning models and techniques to parse the error logs provided by the network monitor 401. For example, the MLM may include a support vector machine to find patterns in the error logs that are associated with a particular error and/or root cause. A neural network of the MLM may then be used to determine the most likely root cause based at least in part of the patterns found in the error logs. One of ordinary skill in the art would recognize many different configurations and possibilities.

The error identification module 404 may then output data indicating a root cause of the error. The data may also indicate the user data associated with one or more of the UE's connected to the 5G network. The data may then be provided to the routing module 406. The routing module may include one or more MLMs, such as the MLM 306 in FIG. 3. The routing module 406 may also access one or more datastores associated with one or more service providers and/or previous errors. The one or more service providers may be associated with respective components of the 5G network 408. Each of the one or more service providers may also include one or more individuals that are associated with a respective component(s) of the 5G network 408. In some embodiments, more than one individual may be associated with a respective component. For example, there may be a team lead and an engineer. In some embodiments, the more than one individuals may be associated with the respective component based on an error type. For example, an error of a first type in a network component may be associated with a service provider and a first individual. An error of a second type may be associated with the service provider and a second individual.

In any case, the routing module 406 may utilize the data provided by the error identification module 404 to determine one or more service providers and/or individuals thereof associated with the root cause identified in the data. For example, the root cause may indicate the two network components are associated with the error. The routing module 406 may access a datastore containing records of previous errors. The routing module 406 may then compare the root cause of the error to those in the records associated with the previous error. Based on the comparison, the routing module 406 may then determine that a third network component may require reconfiguring to address the root cause of the error.

Then, the routing module 406 may access records associated with the one or more service providers. For each of the three network components, the routing module 406 may determine a respective service provider and respective individuals of the respective service provider, based at least in part on the records associated with the one or more service providers. The routing module 406 may also determine a destination associated with each of the respective service providers and each of the individuals.

The routing module 406 may then output data indicating the error and the root cause (e.g., the error data 322), the destination of the service provider(s) and individual(s) associated with the error and/or the root cause (e.g., the destination 324), and the user data associated with the one or more UE's connected to the 5G network 408 at the time of the error to the service ticket generator 410. Additionally or alternatively, the network monitor 401 and the error identification module 404 may provide data to the service ticket generator 410. For example, network monitor 401 may provide the network metadata and an indication of the user data to the service ticket generator 410. The error identification module 404 may provide data indicating the error and/or root cause to the service ticket generator 410.

The service ticket generator 410 may compile the data received from the routing module 406, the network monitor 401, and/or the error identification module 404. The service ticket generator 410 may then generate a service ticket (e.g., the service ticket 314 in FIG. 3) where the service ticket indicates one or more network components associated with the root cause, the error, and/or the solution to the root cause. The service ticket generator 410 may also include a link to the user data in the service ticket. The user data may include communication metadata typically collected by wireless network provider, such as a call data record (CDR). The service ticket generator 410 may then output the service ticket such that the computing device 402 transmits the service ticket to the appropriate service provider(s) and individual(s).

The service ticket generator 410 may also include an MLM, configured to determine a priority of the service ticket. The MLM of the service ticket generator may utilize the data from the routing module 406, the network monitor 401, and/or the error identification module 404. For example, the network monitor 401 may indicate that the error is causing a network outage or other service disruption. The MLM of the service ticket generator 410 may then determine that a priority of the service ticket should be high. The MLM may also consider other service tickets, wherein the root causes of the errors indicated are not yet completely addressed. For example, if a service provider has several other service tickets open, the MLM may consider the priority of the several other service tickets, then select a priority level based at least in part on the priority of the several other service tickets.

Without systems such as those described at least in FIGS. 3 and 4, parsing the error logs may take significant time to identify even relatively clear causes of an error in the 5G network 408. Where more subtle interactions between network components are the root cause of an error, the root cause may not even be found until after a service ticket is generated and transmitted. For example, if, after receiving a service ticket (possibly days after the error) a service provider determines that a second network component is additionally responsible for the error, another service provider may be required to address the second network component. By efficiently identifying the root cause of the error in the first place, the time to provide a solution for the root cause to the 5G network may be greatly reduced. Further, any secondary service providers associated with the solution (e.g., reconfiguring a network component due to a change in another network component) may be identified and provided with a service ticket concurrently with the service providers associated with the error and/or root cause, creating yet more efficiency.

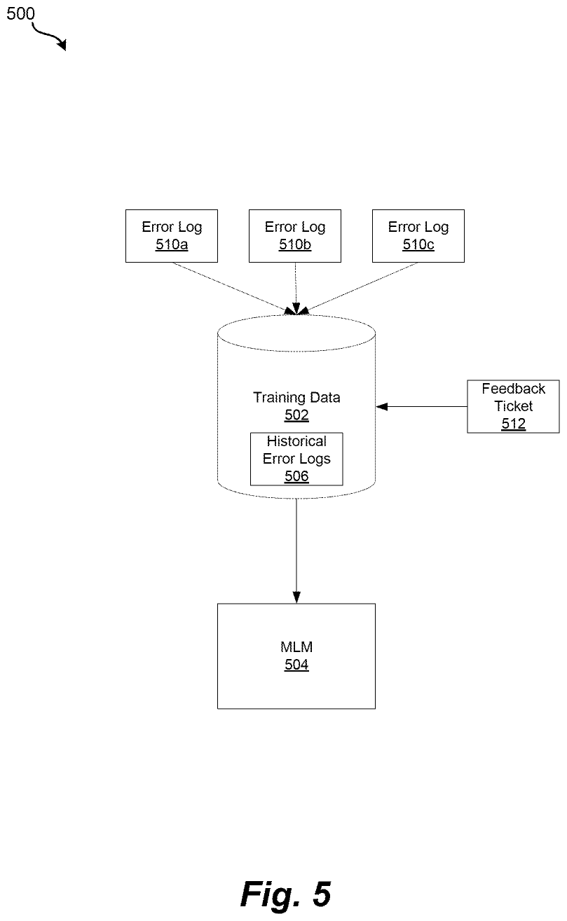

FIG. 5 illustrates a block diagram of a system 500 for training a machine learning model 504 for identifying a root cause of an error, according to certain embodiments. The system 500 may be used in conjunction with any of the systems and/or components thereof described herein, such as the MLM 304 in FIG. 3 and the error identification module 404 in FIG. 4. The system 500 may include training data 202 and the MLM 504. The training data 502 may include historical error logs 506. The historical error logs 506 may include error logs associated with previous errors experienced in a 5G network (e.g., the system 100 in FIGS. 1A and 1B).

In some embodiments, the training data 502 may be associated with a single implementation of a local 5G network. For example, the local 5G network may provide wireless services to a particular region. Any error experienced by the local 5G network may generate an error log 510a. The error log 510a may be used in a system such as the system 300 or 400 to identify a root cause of the error and (ultimately) transmit a service ticket to an appropriate service provider. The error log 510a may then be added to the training data 502. In other embodiments, the training data 502 may include historical error logs from multiple 5G networks. For example, a 5G wireless network provider may administer several 5G networks. Error logs 510b-c may be generated by different 5G networks of the 5G wireless network provider. Each of the error logs 510b-c may then be included in the historical error logs 506.

A feedback ticket 512 may also be provided to and included in the training data 502. The feedback ticket 512 may include an error accuracy rate associated with an error experienced by a 5G wireless network. Even though one feedback ticket 512 is shown, any number of feedback tickets may be included in the training data. For example, each of the error logs 510a-c may have a corresponding feedback ticket. The feedback ticket 512 may be used to modify the training data 502. The feedback ticket 512 may also indicate an actual root cause of the error. For example, if the error accuracy rating is low (indicating that the root cause indicated in a related service ticket was incorrect), the feedback ticket 512 may indicate the actual root cause of the error. Therefore the training data 502 may now include an association of the actual root cause of the error and any relevant error log(s).

The MLM 504 may then be trained using the training data 502. The MLM 504 may include and/or employ an artificial neural network, Bayesian network, ridge regression model, K-nearest neighbors, and/or other machine learning models and techniques to parse error logs associated with errors in the 5G network. For example, the MLM 504 may include a support vector machine to find patterns in the error logs that are associated with a particular error and/or root cause. A neural network of the MLM 504 may then be used to determine the most likely root cause based at least in part of the patterns found in the error logs. One of ordinary skill in the art would recognize many different configurations and possibilities.

In some embodiments, each 5G network of a 5G wireless network provider may include a system such as the systems 300 and/or 400. Each system may be trained on a central set of training data, such as the training data 502. Each system may therefore learn from errors experienced by other 5G networks. Each system may also have a corresponding set of training data, including error logs and feedback tickets unique to an associated 5G network. Thus, each system may be trained on a central data set, and tuned by a unique, local data set. This may result in a faster and more accurate identification of the root causes experienced by each 5G network of the 5G wireless network provider.

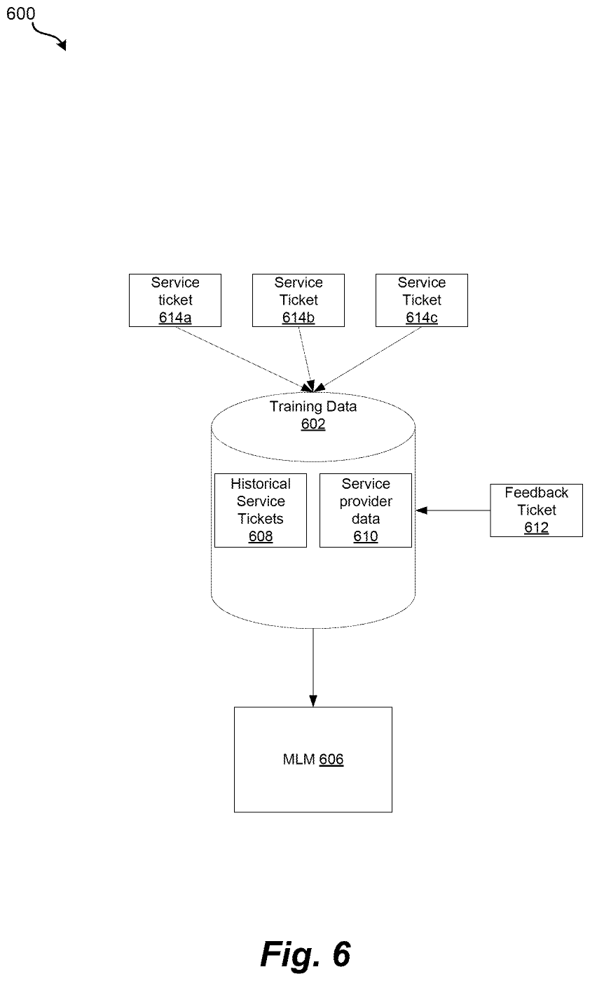

FIG. 6 illustrates a block diagram of a system 600 for training a machine learning model 606 for identifying a root cause of an error, according to certain embodiments. The system 500 may be used in conjunction with any of the systems and/or components thereof described herein, such as the MLM 306 in FIG. 3 and the routing module 406 in FIG. 4. The system 600 may include training data 602 and the MLM 606. The training data 602 may include historical service tickets 608 and service provider data 610. The historical service tickets 608 may include service tickets generated as a result of previous errors in a 5G network. Each of the historical service tickets 604 may indicate an error, a root cause of the error, a service provider associated with one or more components of included or affected by the error, network metadata associated with the 5G network at the time of the error, and/or other such information.

In some embodiments, the training data 602 may be associated with a local 5G network of a 5G wireless network provider. When the 5G network experiences an error, a service ticket 614a may be generated by a system such as the systems 300 and 400 in FIGS. 3 and 4, respectively. The system may transmit the service ticket 614a to an associated service provider and also cause the service ticket 614a to be included in the training data 602 and/or the historical service tickets 608. In other embodiments, the training data 602 may be associated with the 5G wireless network provider more broadly. Then, errors experienced by different 5G networks of the 5G wireless network provider may result in service tickets 614b-c, with each service ticket 614b-c being associated with a different 5G network. Thus, the training data 602 may include service tickets from several 5G networks.

A feedback ticket 612 may also be provided to and included in the training data 602. The feedback ticket 512 may include a routing accuracy rate associated with an error and/or service ticket experienced by a 5G wireless network. Even though one feedback ticket 612 is shown, any number of feedback tickets may be included in the training data. For example, each of the service tickets 614a-c may have a corresponding feedback ticket. The feedback ticket 612 may be used to modify the training data 602. For example, the feedback ticket 612 may indicate an additional service provider is associated with a solution for the root cause of the error. The training data 602 may be updated to associate the additional service provider with the solution for the root cause.

Service tickets may be generated on a per-error basis, meaning that each error is associated with a single service ticket. However, errors may share common root causes. A service provider may therefore receive multiple service tickets for errors that share common root causes. By combining error data from errors sharing common root causes, the service provider may identify a solution to the root cause and provide the solution more efficiently.

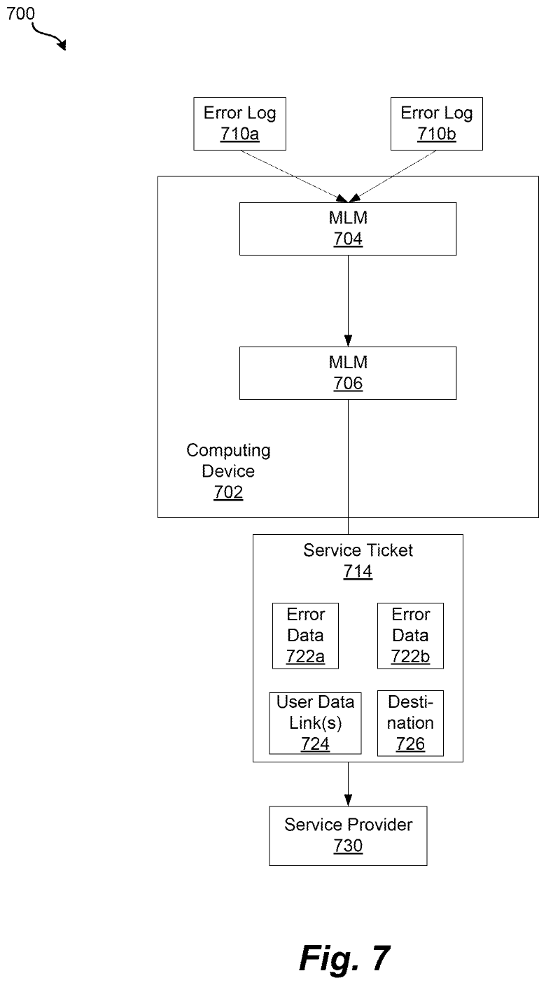

FIG. 7 illustrates a system 700 for providing a single service ticket 714 associated with errors sharing a common root cause to a service provider 730, according to certain embodiments. The system 700 may be implemented by any or all of the systems disclosed herein, such as the system 300 in FIG. 3. The system 700 may include a computing device 702. The computing device 702 may include an MLM 704 and an MLM 706. The MLM 704 may be similar to the MLM 304 in and the MLM 706 may be similar to the MLM 306.

The computing device 702 may receive error logs 710a-b from one or more wireless networks. The error logs 710a-b may be associated with respective errors. The respective errors may occur at the same time in different 5G networks, different times in the same 5G network, etc. The respective errors may be identical, in that the same error occurred for the same reason(s), or the respective errors may be different errors. In the embodiment shown, each of the error logs 710a-b may indicate that a network component associated with a service provider 730 is implicated in each respective error.

The MLM 704 may determine a root cause of the respective errors, based at least in part on data included in the error logs 710a-c. The MLM 704 may output data indicating that the network component is a root cause of the both respective errors. The data may then be provided to the MLM 706 may then determine that the service provider 730 is associated with the network component, and determine a destination 726 associated with the service provider 730 and/or individuals thereof. The MLM 706 nay then output data indicating the destination 726, the service provider 730, and other such information.

Using the data output by the MLM 706 and/or the MLM 704, the computing device may generate a single service ticket 714. In some embodiments, a third MLM may be used to determine a priority of the service ticket 714, as described above. The service ticket 714 may include error data 722a associated with the error log 710a and error data 722b associated with the error log 710b. The service ticket 714 may also include user data link(s) 724 to user data associated with the respective errors. Then, the computing device 702 may transmit the service ticket 714 to the service provider 730.

Service tickets may be generated on a per-error basis, meaning that each error is associated with a single service ticket. However, errors may share common root causes. A service provider may therefore receive multiple service tickets for errors that share common root causes. By combining error data from errors sharing common root causes, the service provider may identify a solution to the root cause and provide the solution more efficiently.

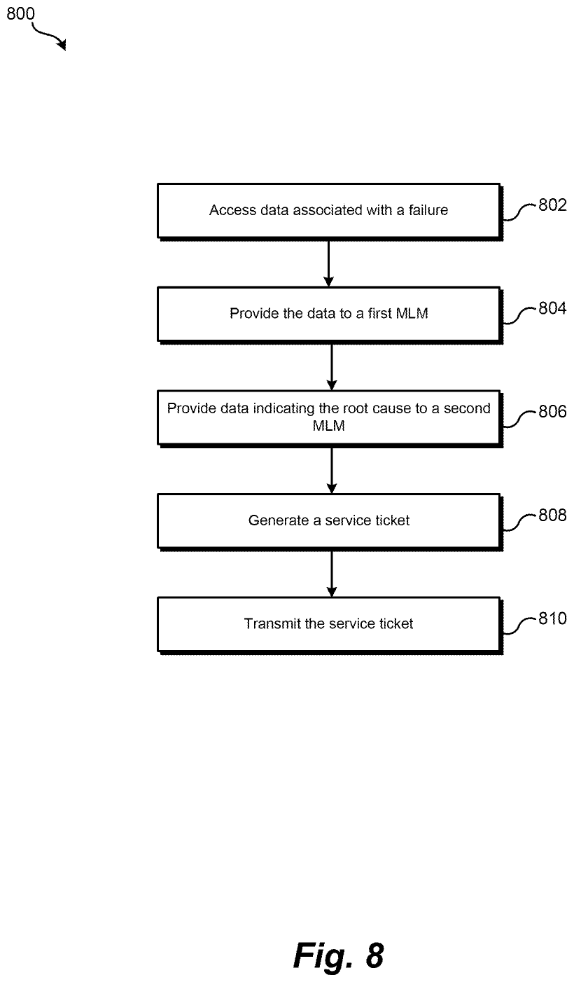

FIG. 8 illustrates a flowchart of a method 800 for determining a root cause of an error and delivering a service ticket, according to certain embodiments. The method 800 may be performed by some or all of the systems described herein, such as the systems 300, 400, 500, 600 and 700 in FIGS. 3-7. Furthermore, some or all of the steps may be performed in a different order than is described here or may be combined in a single step. Some of the steps may skipped altogether.

At step 802, the method 800 may include accessing, by a computing device, data associated with a failure of a 5G network component. The computing device may be similar to the computing device 402 in FIG. 4. The data associated with the failure of the 5G network component may include one or more error logs generated by the computing device (e.g., via the network monitor 401) and/or error logs generated by one or more network components of the 5G network. One or more of the error logs may include network metadata, user data associated with one or more UEs connected to the 5G network, and other such data. The 5G network may be a live 5G network or a test 5G network.

At step 804, the method 800 may include providing, by the computing device, the data associated with the failure of the 5G network to a first MLM. The first MLM may be similar to the MLM 504 in FIG. 5, and include similar functionalities thereof. The MLM may therefore be trained at least in part on historical data logs to determine a root cause of the failure. The method 800 may also include receiving, by the first MLM, an error log associated with the failure of the 5G network component. The error log may include one or more of the error logs generated by the computing device and/or the one or more 5G network components. The first MLM may the identify a line in the error log that corresponds to the failure of the 5G network component. The MLM may then determine the root cause of the failure, based at least in part on the line in the error log. The first MLM may then output data indicating the root cause of the failure of the 5G network component.

At step 806, the method 800 may include providing, by the computing device, data indicating the root cause of the failure to a second MLM. The data indicating the root cause may be the output of the first MLM. The second MLM may be similar to the MLM 606 in FIG. 6 and include similar functionalities thereof. The second MLM may be trained, at least in part, using historical service tickets associated with previous errors and/or service provider data. The second MLM may be configured to determine one or more service providers and respective destinations associated with the root cause. In some embodiments, the method 800 may include receiving, by the second MLM, the data indicating the root cause of the failure of the 5G network component. The second MLM may then determine one or more service providers associated and respective destinations based at least in part on the data indicating the root cause. The second MLM may also determine one or more individuals (e.g., an engineer, a team lead, etc.) of the one or more service providers associated with the root cause failure of the 5G network component and/or a solution to address the root cause. The second MLM may then output data indicating at least one or the one or more service providers, the one or more individuals, and the respective destinations.

At step 808, the method 800 may include generating, by the computing device, a service ticket. The service ticket may be generated by a service ticket generator such as the service ticket generator 410 in FIG. 4. The service ticket may include data indicating the root cause of the failure, the respective destinations associated with the root cause, a link to user data associated with the failure, and other such information. The link to the user data may cause the user data to be displayed and/or downloaded to a user device in response to a user input. The user data may include CDRs and/or other such communications metadata.

At step 810, the method 800 may include transmitting, by the computing device, the service ticket to the respective destinations of the service providers associated with the root cause. In some embodiments, the computing device may receive a feedback ticket associated with the service ticket. The feedback ticket may include a first accuracy rating corresponding to the root cause of the failure of the 5G network component (e.g., the error accuracy rating described in FIG. 3). The feedback ticket may also include a second accuracy rating corresponding to at least one of the one or more service providers, the respective destinations, and the one or more individuals (e.g., the routing accuracy rating). The computing device may then retrain the first MLM based at least in part on the first accuracy rating. The computing device may then retrain the second MLM based at least in part on the second accuracy rating.

In some embodiments, the method 800 may include receiving, by the computing device, data associated with a second failure of a second 5G network component. The computing device may then provide the data associated with the second failure to the first MLM such that the first MLM outputs data indicating a root cause of the second failure of the second 5G network component. The computing device may then provide the data indicating the root cause of the second failure to the second MLM. The second MLM may output data indicating one or more service providers and respective destinations associated with the root cause of the second failure of the second 5G network component. The computing device may then determine that the failure of the 5G network device and the second failure of the second 5G network device share a common root cause and are therefore associated with the one or more service providers and respective destinations. The computing device may then generate a single service ticket comprising data indicating the 5G network component and the second failure of the second 5G network component and the respective destinations. The computing device may the transmit the single service ticket to the respective destinations of the one or more service providers associated with the common root cause.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

1. A method, comprising:
accessing, by a computing device, data associated with a failure of a 5G network component;
providing, by the computing device, the data associated with the failure of the 5G network component to a first machine learning model, wherein the first machine learning model is configured to determine and output data indicating a root cause of the failure;
providing, by the computing device, data indicating the root cause of the failure to a second machine learning model, wherein the second machine learning model is configured to determine and output data indicating one or more service providers and respective destinations of the one or more service providers associated with the root cause of the failure of the 5G network component;
generating, by the computing device, a service ticket comprising data indicating the root cause of the failure of the 5G network component and the respective destinations associated with the root cause of the failure of the 5G network component; and
transmitting, by the computing device, the service ticket to the respective destinations of the one or more service providers associated with the root cause of the failure.

2. The method of claim 1, further comprising:
receiving, by the first machine learning model, an error log associated with the failure of the 5G network component;
identifying, by the first machine learning model, a line in the error log that corresponds to the failure of the 5G network component;
determining, by the first machine learning model, the root cause of the failure, based at least in part on the line in the error log; and
outputting, by the first machine learning model, the data indicating the root cause of the failure of the 5G network component.

3. The method of claim 2, further comprising:
receiving, by the second machine learning model, the data indicating the root cause of the failure of the 5G network component;
determining, by the second machine learning model, one or more service providers and respective destinations based at least in part on the data indicating the root cause, the one or more service providers associated with the root cause of the failure of the 5G network component;
determining, by the second machine learning model, one or more individuals of the one or more service providers associated with the failure of the 5G network component; and
outputting, by the second machine learning model, data indicating at least one of the one or more service providers, the one or more individuals, and the respective destinations.

4. The method of claim 3, further comprising:
receiving, by the computing device, a feedback ticket associated with the service ticket, the feedback ticket comprising a first accuracy rating corresponding to the root cause of the failure of the 5G network component and a second accuracy rating corresponding to at least one of the one or more service providers, the respective destinations, and the one or more individuals;
retraining, by the computing device, the first machine learning model based at least in part on the first accuracy rating; and
retraining, by the computing device, the second machine learning model based at least in part on the second accuracy rating.

5. The method of claim 1, wherein the service ticket comprises a link to user data identified by the computing device.

6. The method of claim 1, wherein the first machine learning model is trained at least in part on historical error logs.

7. The method of claim 1, wherein the second machine learning model is trained at least in part on historical service tickets and/or on service provider data.

8. The method of claim 1, further comprising:
accessing, by the computing device, data associated with a second failure of a second 5G network component;
providing, by the computing device, the data associated with the second failure of the second 5G network component to the first machine learning model, such that the first machine learning model outputs data indicating a root cause of the second failure;
providing, by the computing device, the data indicating the root cause of the second failure of the second 5G network component to the second machine learning model such that the second machine learning model outputs data indicating one or more service providers and respective destinations associated with the root cause of the second failure of the second 5G network component;
determining, by the computing device, the failure of the 5G network component and the second failure of the second 5G network component share a common root cause and are associated with the one or more service providers and respective destinations;
generating, by the computing device, a single service ticket comprising data indicating the common root cause of the failure of the 5G network component and the second failure of the second 5G network component, and indicating the respective destinations; and
transmitting, by the computing device, the single service ticket to the respective destinations of the one or more service providers associated with the common root cause.

9. A computing system, comprising:
one or more processors;
a network monitor;
an error identification module;
a routing module;
a service ticket generator; and
a non-transitory computer-readable medium comprising instructions that, when executed by the one or more processors, cause the system to perform operations to:
access, the network monitor, data associated with a failure of a 5G network component;
provide, by the network monitor, the data associated with the failure of the 5G network component to the error identification module, wherein error identification module is configured to determine and output data indicating a root cause of the failure;
provide, by the error identification module, the data indicating the root cause of the failure to the routing module, wherein the routing module is configured to determine and output data indicating one or more service providers and respective destinations of the one or more service providers associated with the root cause of the failure of the 5G network component;
generate, by the service ticket generator, a service ticket comprising data indicating the root cause of the failure of the 5G network component and the respective destinations associated with the root cause of the failure of the 5G network component; and
transmit, by the computing system, the service ticket to the respective destinations of the one or more service providers associated with the root cause of the failure.

10. The computing system of claim 9, wherein the error identification module comprises a machine learning model trained at least in part on historical error logs.

11. The computing system of claim 9, wherein the routing module comprises a machine learning model trained at least in part on historical service tickets.

12. The computing system of claim 9, wherein the computing system is implemented on a distributed cloud-based architecture.

13. The computing system of claim 9, wherein the 5G network is a standalone 5G network implemented on a distributed cloud-based architecture.

14. A non-transitory computer-readable medium comprising instructions that, when executed by a processor of a computing device, cause the computing device to perform operations comprising:
accessing, by the computing device, data associated with a failure of a 5G network component;
providing, by the computing device, the data associated with the failure of the 5G network component to a first machine learning model, wherein the first machine learning model is configured to determine and output data indicating a root cause of the failure;
providing, by the computing device, data indicating the root cause of the failure to a second machine learning model, wherein the second machine learning model is configured to determine and output data indicating one or more service providers of the one or more service providers and respective destinations associated with the root cause of the failure of the 5G network component;
generating, by the computing device, a service ticket comprising data indicating the root cause of the failure of the 5G network component and the respective destinations associated with the root cause of the failure of the 5G network component; and
transmitting, by the computing device, the service ticket to the respective destinations of the one or more service providers associated with the root cause of the failure.

15. The non-transitory computer-readable medium of claim 14, the operations further comprising:
receiving, by the first machine learning model, an error log associated with the failure of the 5G network component;
identifying, by the first machine learning model, a line in the error log that corresponds to the failure of the 5G network component;
determining, by the first machine learning model, the root cause of the failure, based at least in part on the line in the error log; and
outputting, by the first machine learning model, the data indicating the root cause of the failure of the 5G network component.

16. The non-transitory computer-readable medium of claim 15, further comprising:
receiving, by the second machine learning model, the data indicating the root cause of the failure of the 5G network component;
determining, by the second machine learning model, one or more service providers and respective destinations based at least in part on the data indicating the root cause, the one or more service providers associated with the root cause of the failure of the 5G network component;
determining, by the second machine learning model, one or more individuals of the one or more service providers associated with the failure of the 5G network component; and
outputting, by the second machine learning model, data indicating at least one of the one or more service providers, the one or more individuals, and the respective destinations.

17. The non-transitory computer-readable medium of claim 16, further comprising:
receiving, by the computing device, a feedback ticket associated with the service ticket, the feedback ticket comprising a first accuracy rating corresponding to the root cause of the failure of the 5G network component and a second accuracy rating corresponding to at least one of the one or more service providers, the respective destinations, and the one or more individuals;
retraining, by the computing device, the first machine learning model based at least in part on the first accuracy rating; and
retraining, by the computing device, the second machine learning model based at least in part on the second accuracy rating.

18. The non-transitory computer-readable medium of claim 14, wherein the 5G network is a standalone 5G network implemented on a distributed cloud-based architecture.

19. The non-transitory computer-readable medium of claim 14, wherein the first machine learning model is trained at least in part on historical error logs.

20. The non-transitory computer-readable medium of claim 14, wherein the second machine learning model is trained at least in part on historical service tickets and/or on service provider data.
